(19) United States
(12) Patent Application Publication
(10) Pub. No.: US 2026/0080589 A1
(43) Pub. Date: Mar. 19, 2026

(54) ELECTRONIC DEVICE, CONTROL METHOD, AND STORAGE MEDIUM

(71) Applicant: CANON KABUSHIKI KAISHA, Tokyo (JP)

(72) Inventor: Yuki MATSUYAMA, Kanagawa (JP)

(21) Appl. No.: 19/311,072

(22) Filed: Aug. 27, 2025

(30) Foreign Application Priority Data
Sep. 17, 2024 (JP) 2024-160327

(51) Int. Cl. G06T 11/60; G06K 15/02

(52) U.S. Cl. CPC G06T 11/60; G06K 15/1843; G06T 2200/24

(57) ABSTRACT

An electronic device includes: an acceptance unit that accepts, from a user, input of a characteristic of content to be generated; an acquisition unit that acquires information of an output destination of the content to be generated; an input unit that performs control so as to input, into a content generation unit, a query including information representing the characteristic of the content to be generated for which input has been accepted by the acceptance unit and information of the output destination acquired by the acquisition unit; and an output unit that performs control to output, to the output destination, content generated by the content generation unit based on the query.

### BACKGROUND

### Field of the Technology

The present disclosure relates to an electronic device, a control method, and a storage medium comprising a system for providing input to a generative AI.

### Description of the Related Art

In recent years, generative AI (Artificial Intelligence) has been known. A generative AI is one type of machine-learning model that is capable of generating new data by utilizing learned data, and generative AIs are widely used as interactive AIs capable of chat-style interaction and as image generation AIs capable of generating images, and the like.

Japanese Patent Laid-Open No. 2019-101991 describes identifying a plurality of conversion candidate images included in the same category from a plurality of conversion candidate images determined in accordance with an input by a user. Japanese Patent Laid-Open No. 2019-018394 describes a printing apparatus that enables execution of a printing process by appropriately selecting a server corresponding to a connection partner apparatus.

### SUMMARY

The present disclosure provides an electronic device, a control method, and a storage medium for more easily generating content in accordance with a user's intent using a generative AI.

The present disclosure in one aspect provides an electronic device, comprising: at least one memory and at least one processor which function as: an acceptance unit configured to accept, from a user, input of a characteristic of content to be generated; an acquisition unit configured to acquire information of an output destination of the content to be generated; an input unit configured to perform control so as to input, into a content generation unit, a query including information representing the characteristic of the content to be generated for which input has been accepted by the acceptance unit and information of the output destination acquired by the acquisition unit; and an output unit configured to perform control to output, to the output destination, content generated by the content generation unit based on the query.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating a configuration of a system.

FIG. 2 is a diagram illustrating a block configuration of an apparatus.

FIG. 3 is a diagram illustrating a block configuration of an apparatus.

FIG. 4 is a flowchart illustrating processing in a first application.

FIG. 5 is a flowchart illustrating processing in a second application.

FIG. 6 is a diagram illustrating a query.

FIG. 7 is a diagram illustrating a user interface screen.

FIG. 8 is a diagram illustrating a user interface screen.

FIG. 9 is a diagram illustrating a user interface screen.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

There is a need for a mechanism that can more easily generate content in accordance with the intent of the user by using generative AI.

According to the present disclosure, it is possible to more easily generate content in accordance with the intent of the user by using generative AI.

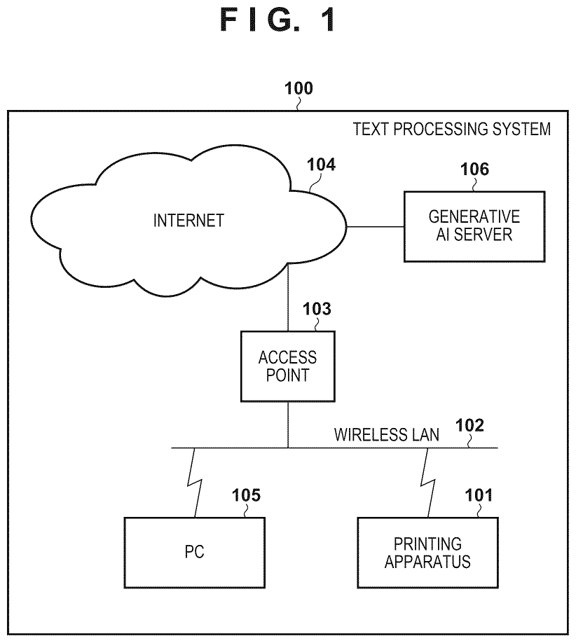

FIG. 1 is a diagram illustrating an example of a configuration of a content generation system according to the present embodiment. In a content generation system 100, a PC 105 and a printing apparatus 101 are connected to each other in a communication-enabling manner via a wireless LAN 102. In addition, the PC 105 and the printing apparatus 101 are able to access the Internet 104 via an access point 103. With such a configuration, the PC 105 and the printing apparatus 101 can communicate with a generative AI server 106 that provides a generative AI (Artificial Intelligence) service and is connected to the Internet 104. Generative AI is a machine learning model constructed using deep learning, and by the generative AI service, a more creative product can be outputted with respect to content such as images, text, moving images, and sounds. ChatGPT, for example, is a known generative AI service that uses a text-generating language model, and is a conversational AI service for realizing a human-like conversation. Note that as long as the generative AI server 106 is an external system using generative AI, the generative AI server 106 may be a single server apparatus, or may be of a form in which a plurality of server apparatuses cooperate with each other.

The PC 105 is an information processing apparatus having a communication function for a wireless LAN, a wired LAN, or the like. Note that wireless LAN may be referred to as WLAN (Wireless LAN). As the PC 105, for example, a smartphone, a notebook PC, a tablet terminal, or a PDA (Personal Digital Assistant) is used. The PC 105 can communicate with the printing apparatus 101 via the wireless LAN 102. For example, the PC 105 may instruct the printing apparatus 101 via the wireless LAN 102 to perform a printing function or a scanning function. In addition, the PC 105 and the printing apparatus 101 may be directly connected to each other without going through the access point 103. That is, the PC 105 can communicate with the printing apparatus 101 by a direct connection. Note that a wired network may be used as a network between the PC 105, the printing apparatus 101, and the access point 103, or for a part of such a network.

The printing apparatus 101 is an example of a printing apparatus having a printing function. The printing apparatus 101 may be configured as a multifunctional printer (MFP) having a reading function (scanner), a FAX function, and a telephone function. The printing apparatus 101 has a communication function by which it is able to wirelessly communicate with the PC 105. Although the printing apparatus 101 is described as an example in the present embodiment, an apparatus in a form different from that of the printing apparatus 101 may be used. For example, a facsimile apparatus, a scanner apparatus, a projector, a mobile terminal, a smartphone, a notebook PC, a tablet terminal, a PDA, a digital camera, a music playback device, a TV, a smart speaker, AR (Augmented Reality) glasses, or the like, having a communication function, may be used. The printing apparatus 101 receives print data including image data from the PC 105 connected via the access point 103, for example, and forms an image based on the print data. Alternatively, the printing apparatus 101 transmits the image data read by, for example, the scanning function to the PC 105 connected via the access point 103. The printing apparatus 101 can also communicate other control information and the like over a network connected via the access point 103.

The access point 103 is a communication apparatus that is provided separately (externally) from the PC 105 and the printing apparatus 101 and operates as a WLAN base station apparatus. Note that the access point 103 may be referred to as the external access point 103 or the external wireless base station. The communication apparatus having WLAN communication function can perform communication in WLAN infrastructure mode via the access point 103. In the present embodiment, the PC 105 and the printing apparatus 101 are also examples of communication apparatuses. Note that the wireless infrastructure mode may be referred to as the “wireless infra mode”. The wireless infrastructure mode is, for example, a mode in which the printing apparatus 101 communicates with the PC 105 via the access point 103, to which the printing apparatus 101 is connected. The access point 103 communicates with an (authenticated) communication apparatus that has permitted connection to itself, and the access point 103 relays wireless communication between that communication apparatus and other communication apparatuses. The access point 103 is connected to a wired LAN communication network and relays communications between a communication apparatus connected to the network and another communication apparatus wirelessly connected to the access point 103. In addition, in a case where the authentication method of the network constituted by the access point 103 is a method that uses an authentication server (in a case where the access point 103 supports an authentication method that uses an authentication server), the access control is performed by performing authentication of a communication apparatus connected to the network in cooperation with the authentication server (not illustrated). Note that the access point 103 may support an authentication method that does not use an authentication server.

Using a WLAN communication function that the PC 105 and the printing apparatus 101 each have, the PC 105 and the printing apparatus 101 can perform wireless communication in a wireless infrastructure mode via the external access point 103 or in a peer-to-peer mode without going through the external access point 103. Note that the peer-to-peer mode may be referred to as “P2P mode”, or “wireless direct mode” in relation to the wireless infrastructure mode. P2P mode is, in other words, a mode in which the printing apparatus 101 directly communicates with the PC 105 without going through the access point 103. P2P modes include a Wi-Fi Direct (registered trademark) mode, a software access point (soft AP) mode, and the like. Note that Wi-Fi Direct (registered trademark) is sometimes referred to as WFD. Specifically, the wireless direct mode can be said to be a communication mode that is compliant with the IEEE 802.11 series.

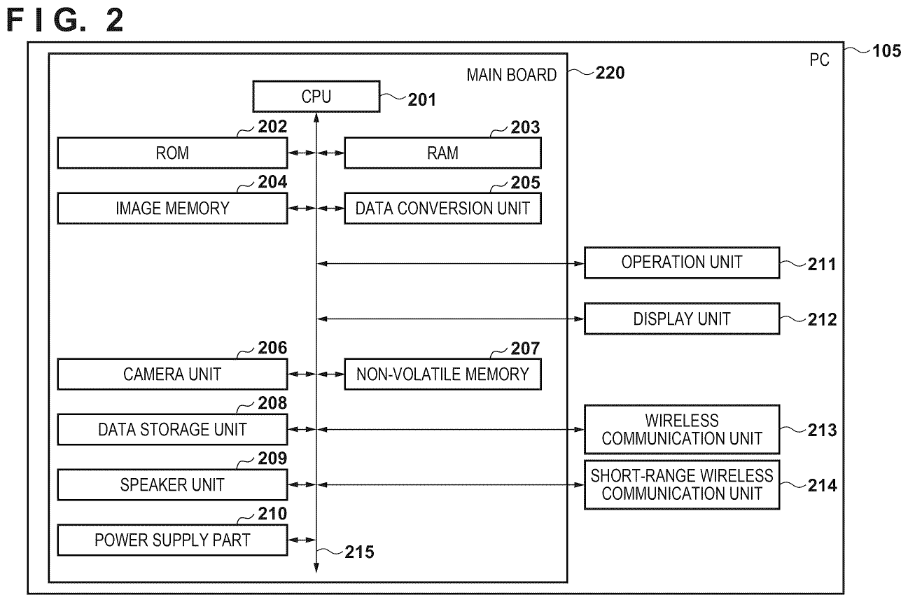

FIG. 2 is a diagram illustrating an example of a configuration of the PC 105. The PC 105 includes a main board 220 that controls the entire apparatus, a wireless communication unit 213 that performs WLAN communication, a display unit 212, an operation unit 211, and a short-range wireless communication unit 214 that performs wireless communication differing from that of the wireless communication unit 213. The main board 220 includes, for example, a CPU 201, a ROM 202, a RAM 203, an image memory 204, a data conversion unit 205, a camera unit 206, a non-volatile memory 207, a data storage unit 208, a speaker unit 209, and a power supply unit 210. The functional units in the main board 220 are connected to each other via a system bus 215. The main board 220 and the wireless communication unit 213 are connected to each other, and the main board 220 and the short-range wireless communication unit 214 are connected to each other via a dedicated bus, for example. The main board 220 and the display unit 212 are connected to each other, and the main board 220 and the operation unit 211 are connected to each other via, for example, a dedicated bus.

The CPU 201 is a system control unit that controls the entire PC 105. The operation of the PC 105 described in the present embodiment is realized, for example, by the CPU 201 reading a program stored in the ROM 202 into the RAM 203 and executing the program. Note that dedicated hardware for each process may be prepared. The ROM 202 stores control programs executed by the CPU 201, an embedded operating system (OS) program, and the like. The CPU 201 executes control programs stored in the ROM 202 under the control of the built-in OS stored in the ROM 202, thereby performing software control such as scheduling and task switching. In addition, the ROM 202 stores an application (printing app) or the like that generates information that can be interpreted by the printing apparatus 101. The information that can be interpreted by the printing apparatus 101 is information corresponding to functions that can be executed by the printing apparatus 101, and the application can instruct the printing apparatus 101 to perform settings for printing and scanning and the like, or to execute a respective function. The RAM 203 is constituted by SRAM (Static RAM) or the like. The RAM 203 stores data such as program control variables, setting values registered by the user, management data of the PC 105, and the like. The RAM 203 may be used as various work buffers. The image memory 204 is constituted by a DRAM (Dynamic RAM) memory or the like. The image memory 204 temporarily stores image data received via the wireless communication unit 213 and image data read from the data storage unit 208 in order to be processed by the CPU 201. The non-volatile memory 207 is constituted by a memory such as a flash memory, for example, and continues to store data even when the power of the PC 105 is turned off. Note that the memory configuration of the PC 105 is not limited to the above-described configuration. For example, the image memory 204 and the RAM 203 may be shared, or data may be backed up, or the like, using the data storage unit 208. Further, although a DRAM is given as an example of the image memory 204, another storage medium such as a hard disk or a non-volatile memory may be used.

The data conversion unit 205 performs analysis of data in various formats, and data conversion such as color conversion and image conversion. The camera unit 206 has a function of electronically recording and encoding an image inputted via a lens. Image data obtained by imaging by the camera unit 206 is stored in the data storage unit 208. The speaker unit 209 performs control for realizing a function of inputting or outputting sound. The power supply unit 210 is, for example, a portable battery, and controls the supply of power into the apparatus. The display unit 212 electronically controls display content, and executes control for displaying of various types of input content, operation conditions and status conditions of the PC 105, and the like. Upon acceptance of a user operation, the operation unit 211 performs control such as that for generating an electric signal corresponding to an operation and outputting the electric signal to the CPU 201.

The PC 105 performs wireless communication using the wireless communication unit 213, and performs data communication with other communication apparatuses such as the printing apparatus 101. The wireless communication unit 213 converts data into packets and transmits the packets to another communication apparatus. In addition, the wireless communication unit 213 restores packets from another external communication apparatus to original data and outputs the restored data to the CPU 201. The wireless communication unit 213 is a unit for realizing communication conforming to a standard such as WLAN. The short-range wireless communication unit 214 performs communication by a communication method other than that of the wireless communication unit 213 such as Bluetooth (registered trademark), for example. The configurations of the PC 105 and the main board 220 are not limited to the above. For example, individual functions of the main board 220 realized by the CPU 201 may be realized by a processing circuit such as an application-specific integrated circuit (ASIC), or may be realized by hardware and/or software.

FIG. 3 is a block diagram showing an example of a configuration of the printing apparatus 101. The printing apparatus 101 includes a main board 320 that controls the entire apparatus, a USB communication unit 307, a wireless communication unit 309, a wired communication unit 310, an operation display unit 312, a power button 313, a printing unit 315, and a scanning unit 317.

The main board 320 is provided with a microprocessor-type CPU 301. The CPU 301 controls the printing apparatus 101 in accordance with a control program stored in a program memory 302, in the form of a ROM, connected via an internal bus 318 and the content stored in a data memory 303 in the form of a RAM. The operation of the printing apparatus 101 described in the present embodiment is realized, for example, by the CPU 301 reading a program stored in the program memory 302 into the data memory 303 and executing the program. The CPU 301 controls a scan control unit 316 to cause the scanning unit 317 to optically read a document, and stores the read data in an image memory in the data memory 303. The scan control unit 316 is an interface for connecting the scanning unit 317 and the main board 320, and the scan control unit 316 performs conversion of the data format of scanned images and the like. For example, the CPU 301 controls a print control unit 314 to cause the printing unit 315 to print, onto a printing medium, an image of the read data stored in image memory in the data memory 303 (copying function). The print control unit 314 is an interface for connecting the printing unit 315 and the main board 320, and the print control unit 314 performs conversion of image data and the like. A data conversion unit 304 performs analysis of data in various formats, and data conversion such as color conversion and conversion of image data into print data. An encoding/decoding processing unit 305 performs encoding processing and decoding processing and enlargement/reduction processing on image data (such as JPEG or PNG) handled by the printing apparatus 101.

The CPU 301 controls the USB communication unit 307 via a USB communication control unit 306 to perform USB communication by a USB connection with the external PC 105. The CPU 301 controls an operation control unit 311 to accept operation information from the power button 313 and the operation display unit 312. The CPU 301 controls the operation control unit 311 to display, for example, a state of the printing apparatus 101 and a function selection menu on the operation display unit 312. The CPU 301 controls the wireless communication unit 309 and the wired communication unit 310 via a communication control unit 308 in accordance with the operation information accepted by the operation display unit 312. For example, the CPU 301 changes a setting for the communication method and a setting for connecting to the network in accordance with the operation information.

The wireless communication unit 309 is a unit capable of providing a WLAN communication function. That is, the wireless communication unit 309 converts data into a packet and transmits the packet to another communication apparatus in accordance with the WLAN standard. In addition, the wireless communication unit 309 restores packets from another external communication apparatus to original data and outputs the restored data to the CPU 301. The wireless communication unit 309 is configured to be capable of performing data (packet) communication in a WLAN system conforming to, for example, the IEEE 802.11 standard series (IEEE 802.11a/b/g/n/ac/ax or the like). However, the present disclosure is not limited to this configuration, and the wireless communication unit 309 may be capable of performing WLAN communication in conformity with other standards. Further, the wireless communication unit 309 is capable of executing communication in WFD mode, communication in P2P mode, communication in the wireless infrastructure mode, and the like. Note that the PC 105 and the printing apparatus 101 can perform wireless communication based on WFD mode, and the wireless communication unit 309 has a soft AP function or a group owner function. That is, the wireless communication unit 309 can establish a communication network in P2P mode or determine channels used for communication in P2P mode.

The wired communication unit 310 is a unit for performing wired communication. The wired communication unit 310 is capable of data (packet) communication in an IEEE 802.3 series-compliant wired LAN (Ethernet) system, for example. In the wired communication using the wired communication unit 310, communication in the wired communication mode is possible. The wired communication unit 310 is connected to the main board 320 via a bus cable or the like.

The printing apparatus 101 has an OCR (Optical Character Recognition) function for recognizing text information in an image read by a scanning function and extracting text data. The OCR function may be realized by the scan control unit 316, for example. The OCR function generates data in a text-searchable file format. Examples of such data include PDF and XPS (XML Paper Specification). The printing apparatus 101 can store (or transmit) a file generated by the OCR function in a designated internal or external storage destination. The instruction to set and execute the OCR function may be performed on a control panel on the printing apparatus 101 or may be performed on the printing apparatus 101 through an application installed in the PC 105. The printing apparatus 101 is not limited to the configuration illustrated in FIG. 3, and the printing apparatus 101 has a configuration corresponding to functions that can be implemented by a device applied as the printing apparatus 101 as appropriate.

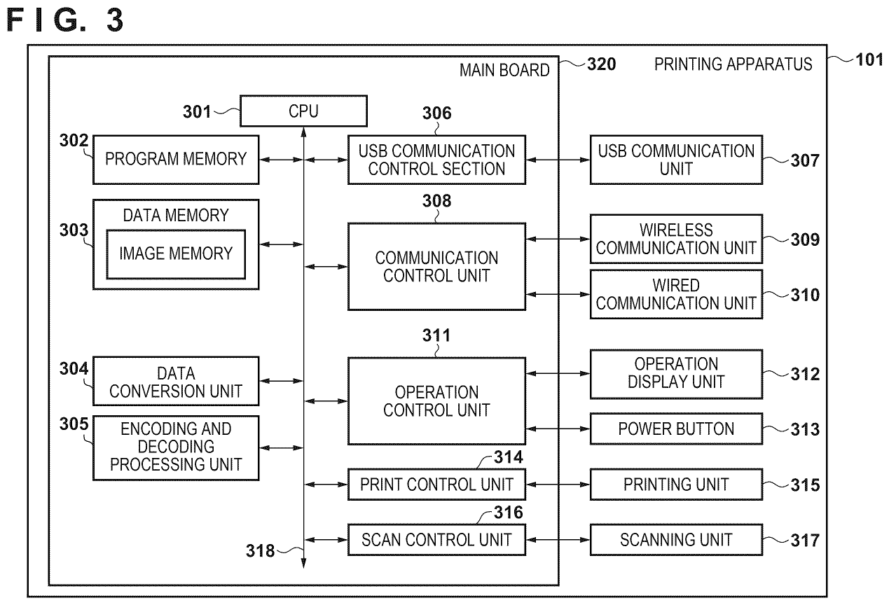

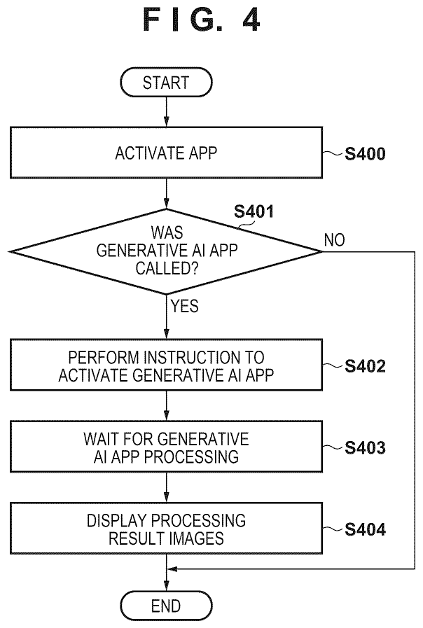

FIG. 4 is a flowchart illustrating a process executed by a predetermined application (hereinafter, referred to as the predetermined app) in the present embodiment. The predetermined app is, for example, a printing app having a printing function for generating an image and performing printing in the printing apparatus 101. In the present embodiment, it is assumed that the predetermined app and a generative AI app are installed in the PC 105. In other words, operations of the predetermined app and the generative AI app are operations of the PC 105. However, the predetermined app and the generative AI app may be programs installed in the printing apparatus 101. In other words, operations of the predetermined app and the generative AI app would be operations of the printing apparatus 101 in that case.

Further, in the present embodiment, the generative AI app is installed in the PC 105 as an app that can cooperate with the predetermined app. The generative AI app may be incorporated in the predetermined app or may be installed separately from the predetermined app. In the present embodiment, cooperation between the predetermined app and the generative app is realized by data from each app being stored in an app cooperation region reserved in the operating system (OS). For example, the generative AI app is activated by the predetermined app storing an activation instruction for activating the generative AI app in the cooperation region. Further, for example, by storing data acquired by the generative app in the cooperation region, the predetermined app can acquire that data. Further, for example, by storing data acquired by the predetermined app in the cooperation region, the generative app can acquire that data (also referred to as data transfer in the present embodiment). In this way, cooperation between the predetermined app and the generative app is possible. In the present embodiment, the cooperation between the predetermined app and the generative AI app is described as being performed via the cooperation region reserved in the OS, but the cooperation between the predetermined app and the generative app may be performed without going through the cooperation region. For example, in a form in which the generative app is incorporated in the predetermined app, the predetermined app may be configured to directly instruct the generative app to activate.

The generative AI app is, for example, an app that is called (activated) by a user to select predetermined items related to image generation on the predetermined app. The generative app displays a screen as illustrated in FIG. 7, which will be described later, and accepts input of characteristics of an image from a user. The input may be a text input or a voice input. For example, an input such as “a landscape image in which a windmill is depicted” is accepted as text input from the user on a dialog screen that asks “What kind of image would you like to generate?”. The generative AI app is an app capable of communicating with the external generative AI server 106. The generative AI app acquires the input of characteristics of the image to be generated from the user, and then generates a query to be transmitted to the generative AI server 106. Information (resolution, image size, and the like) for enabling an image to be outputted by an output apparatus (a printing apparatus, a display apparatus, or the like) is automatically added to the query without a user operation. The generated query is transmitted to the generative AI server 106. The generative AI server 106 generates images based on the query transmitted from the PC 105, and transmits the generation result to the PC 105. The generative AI app receives the generation result from the generative AI server 106, and the predetermined app can further acquire and output the generation result.

As described above, in the present embodiment, the predetermined app generates a query to be transmitted to the generative AI server 106 based on the image characteristics inputted by the user. Then, in the generation of the query, information for enabling the output of an image by the output apparatus is automatically given without a user operation. As a result, the following effects can be achieved. Consider a case in which, for example, on an app, a user inputs characteristics of an image to be generated, the input is transmitted to a generative AI server to generate images, and then the images are used by the app. At this time, there is a possibility that an image that does not conform to the purpose of use of the app will be generated. For example, even though borderless printing on a postcard is assumed, an image having an aspect ratio different from that of a postcard may be generated. In this case, when the generated image is used as it is, there arises the problem that full-face borderless printing cannot be performed on a postcard, or that much of the image will be trimmed and lost if full-face borderless printing is performed on a postcard. In addition, when the user re-generates an image with an aspect ratio matching a postcard, the user will have to go through the trouble of inputting detailed conditions such as an aspect ratio, requesting image generation again, and the like. According to the present embodiment, by the generation of the query, since information for enabling the output of the image by the output apparatus is automatically added without a user operation, the user only needs to input the characteristics of the image to be generated, and the convenience of the user can be improved.

The process of FIG. 4 is realized by, for example, the CPU 201 reading a program stored in the computer-readable ROM 202 into the RAM 203 and executing the program. The process of FIG. 4 is started in a state in which the PC 105 has been activated, a home screen has been displayed on the display unit 212, and selection of an app by a user can be accepted.

In step S400, the CPU 201 determines, via the display unit 212, an app for which a selection operation by the user has been accepted. In a case where the app for which the selection operation by the user has been accepted is the predetermined app, the subsequent processing is executed. Meanwhile, in a case where the app for which the selection operation by the user has been accepted is not the predetermined app, the process of FIG. 4 is terminated and that app is activated. Description of the case where the app for which the selection operation by the user has been accepted is not the predetermined app will be omitted.

In step S401, the CPU 201 determines whether or not the generative AI app has been called. In step S401, for example, in a case where a selection of a predetermined item by the user is accepted, it is determined that the generative AI app has been called. If it is determined that the generative AI app has been called, the process proceeds to step S402. On the other hand, when it is determined that the generative AI app has not been called, the process of FIG. 4 is ended.

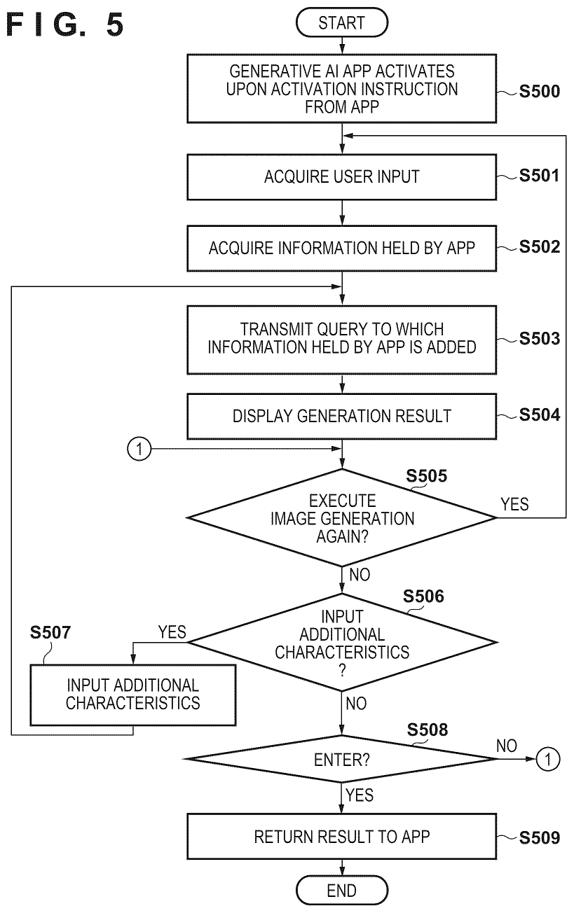

In step S402, the CPU 201 activates the generative AI app. Specifically, for example, the CPU 201 activates the generative AI app by storing an activation instruction for activating the generative AI app in an app cooperation region reserved in the operating system (OS). After the process of step S402, a screen is displayed by the generative AI app, which will be described later with reference to FIG. 5, and user operations are performed in relation to that screen.

In step S403, the CPU 201 awaits the result of the processing by the generative AI app. Specifically, for example, the predetermined app may receive, from the OS, a notification indicating that the processing of the generative AI app is completed.

In step S404, the CPU 201 acquires and outputs the result of the processing (generation result) by the generative AI app. Specifically, for example, first, the generative AI app displays images as the generation result received from the generative AI server 106 on the display unit 212. Then, the generative AI app stores information of an image selected by the user on the screen in the cooperation region of the OS. For example, the predetermined app acquires information (image data or the like) of that image from the cooperation region of the OS as a processing result of the generative AI app upon the trigger of a notification indicating that the processing of the generative AI app has been completed being received from the OS, and outputs the information. At this time, the output apparatus serving as the output destination is, for example, the printing apparatus 101 or a display apparatus such as a display. Processing according to the output destination such as color-space conversion and resolution conversion is executed on the image data or the like acquired from the OS cooperation region.

FIG. 5 is a flowchart illustrating a process executed by the generative AI app according to the present embodiment. The process of FIG. 5 is realized by, for example, the CPU 201 reading a program stored in the computer-readable ROM 202 into the RAM 203 and executing the program. The process of FIG. 5 is started in a state in which the PC 105 is activated and the user is using the predetermined app.

In step S500, the CPU 201 activates the generative AI app by issuing an activation instruction from the predetermined app. Specifically, for example, the generative AI app is activated based on the fact that an instruction to activate the generative AI app from the predetermined app is stored in the OS cooperation region.

In step S501, the CPU 201 accepts input of a user operation through the display unit 212. Specifically, for example, the generative AI app displays a UI screen 700 as illustrated in FIG. 7 on the display unit 212. As illustrated in FIG. 7, the UI screen 700 displays a message asking “What kind of image would you like to generate?” and an input region 701 for accepting characteristics of an image that the user wants to generate. FIG. 7 illustrates an example in which the input region 701 accepts an input such as “a landscape image in which a windmill is depicted”.

In step S502, the CPU 201 refers to the RAM 203 and acquires information held by the predetermined app. Specifically, for example, the generative AI app accesses the OS cooperation region in which the information held by the predetermined app is stored to acquire that information, or, upon the trigger of a notification from the OS, acquires the information held by the predetermined app.

For example, the OS cooperation region may be partitioned by app. The predetermined app may store, in the OS cooperation region, information by which the app can identify itself and information to be transferred to the generative AI app when the predetermined app is activated by a user operation or the like. Here, the information to be transferred to the generative AI app is, specifically, the foregoing information held by the predetermined app. The information by which the predetermined app can be identified is, for example, an app name or an app type (an app for printing, or an SNS (Social Networking Service) app, an image browsing app, or the like).

In a case where the type of the app indicates a printing app, the information held by the predetermined app is, for example, information related to color materials for printing, which are mounted to the printing apparatus 101, which is a printing apparatus registered with the app and which the PC 105 can communicate with. Such information may be, for example, information that cyan ink is low and that there is sufficient magenta, yellow, and black ink, for example. Further, the information held by the predetermined app is, for example, information (including at least one of a type, a size, and an aspect ratio) of a sheet set in the printing apparatus 101.

When the type of the app indicates an SNS app, the information held by the predetermined app is, for example, a condition (aspect ratio, image size limit, etc.) of an image to be posted to the predetermined app. When the type of the app indicates an image browsing app, the information held by the predetermined app is, for example, an image size or capability information of an output destination device (such as a display) for displaying an image.

In step S503, the CPU 201 generates a query to be transmitted to the generative AI server 106 based on the input content from the user acquired by step S501 and the information held by the predetermined app acquired in step S502, and transmits the generated query to the generative AI server 106.

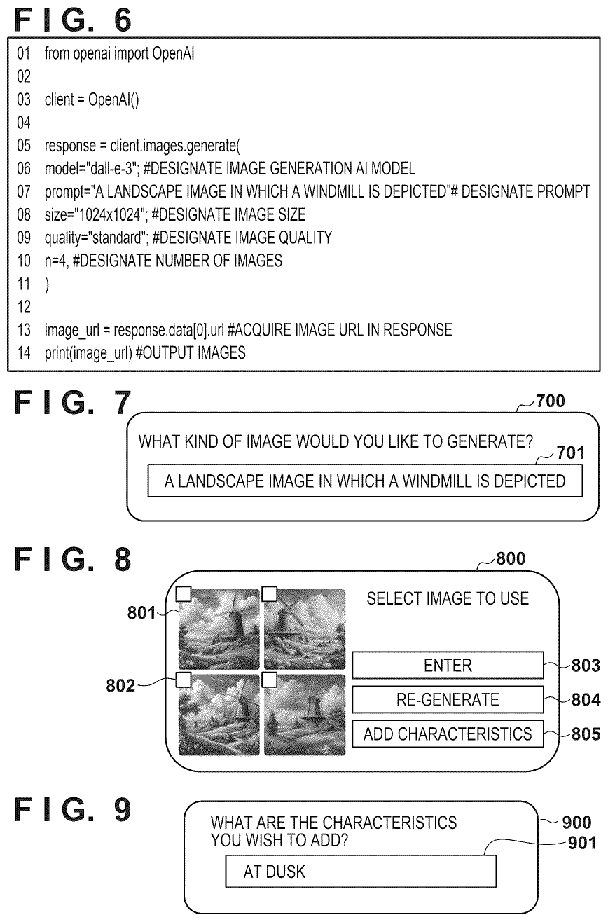

FIG. 6 is a diagram illustrating an example of the query generated in step S503. All of the code illustrated in FIG. 6 is generated as a query. However, the two-digit numbers of each line in FIG. 6 are given for the purpose of illustration and are not part of the actual code. In addition, each character string after a “#” in FIG. 6 is a comment for describing the meaning of the code, and is not part of the actual code.

Lines “01” and “03” in FIG. 6 indicate that a package related to the generative AI tool is to be read and made useable. For example, an open-source code package name or the like is recited.

In line “05” of FIG. 6, a name of a variable for storing a return value of a generate function is specified. The name does not particularly have to be “response”, and may be anything.

In line “06” of FIG. 6, the model of the image generation AI is designated.

In line “07” of FIG. 6, the prompt is designated. As the prompt, content input into the input region 701 of FIG. 7 is designated. That is, the input content from the user acquired by step S501 is designated.

In lines “08” and “09” in FIG. 6, the information held by the predetermined app acquired in step S502 is designated. In FIG. 6, it is assumed that the predetermined app is a printing app. Therefore, the image size corresponding to the paper size and the image quality set by the printing apparatus 101 are designated. As described above, in the present embodiment, setting information necessary for outputting the image by the output apparatus is automatically added to the query without a user operation. For example, setting information (image size, aspect ratio, and the like) necessary for displaying an image on a display apparatus is automatically added to the query. Further, for example, setting information (image quality, paper size, and the like) necessary for causing the printing apparatus 101 to print an image is automatically added to the query. With such a configuration, the user can acquire, from the generative AI server 106, images for which the setting conditions for outputting the image in the apparatus are satisfied, simply by designating the characteristics of the image as the content.

In line “10” of FIG. 6, the number of images for which generation is requested of the generative AI server 106 is designated. For example, in FIG. 6, four is designated. The number of images may be a predetermined value that is specified in advance.

In line “13” of FIG. 6, a URL for the images generated by the generative AI server 106 is designated.

In line “14” of FIG. 6, the output form of the images according to the type of the predetermined app is designated. For example, in FIG. 6, printing of an image is designated.

When a query is transmitted in step S503, the generative AI server 106 generates images based on the transmitted query. At this time, a number of images designated by the query are generated. The generative AI server 106 transmits information of the product to the PC 105. Here, the product is the images. The images may be still images or moving images. Further, the information of the product may be the image data itself or may be a URL indicating a location of the image data.

In step S504, the CPU 201 receives the product information which is a result generated based on the transmitted query. Specifically, for example, still image data is received as information of the product. Then, the CPU 201 displays the product on the display unit 212 based on the received information of the product.

FIG. 8 is a diagram illustrating an example of the screen displayed in step S504. A screen 800 includes images 801. The images 801 are images generated by the generative AI server 106 based on the characteristics of the images to be generated accepted by the predetermined app. Note that there may be one or a plurality of such images. FIG. 8 illustrates an example in which four images are generated by the generative AI server 106. A checkbox 802 is assigned to the upper left corner of each image, and the images can be thereby selected by the user. A message prompting selection of an image is displayed on the screen 800. In FIG. 8, a message stating “Please select an image to use” is displayed. When the user selects a desired image 801 using a checkbox 802 and presses an enter button 803, information of the selected image 801 is stored in the cooperation region of the OS. On the screen 800, a button 804 for accepting an instruction to re-execute generation of images and a button 805 for adding characteristics of the images to be generated are displayed.

The image 801 satisfies both the content input from the user and the condition for outputting the image on the apparatus. Specifically, for example, the images 801 are landscape images in which a windmill is depicted, as inputted by the user in the input region 701, and are images in which the condition (print settings) for the predetermined app, which is a printing app, to perform printing in the printing apparatus 101 are satisfied. For example, an aspect ratio of the generated images is a ratio (for example, 100 mm×148 mm) that matches a postcard, since the aspect ratio is automatically designated in the query so as to match a postcard, which is to be the printed output. Therefore, the user can use the generated image as it is, that is, without trimming, and can suitably perform full-face/borderless printing on a postcard. Therefore, it is possible to avoid situations in which full-face borderless printing cannot be performed on a postcard, and situations such as where much of the image will be trimmed and lost if full-face borderless printing is performed on a postcard. As described above, according to the present embodiment, it is possible to more easily generate suitable images by using the generative AI app.

In step S505, the CPU 201 determines whether to re-execute generation of images based on a user operation accepted via the display unit 212. Specifically, for example, when the button 804 of the screen 800 is pressed, it is determined that the generation of images is to be executed again. When it is determined that the generation of images is to be executed again, the processing from step S501 is repeated. On the other hand, if it is determined that the generation of images is not to be executed again, the processing proceeds to step S506. At this time, the characteristics inputted in the input region 701 are maintained.

In step S506, the CPU 201 determines whether to add image characteristics based on a user operation accepted via the display unit 212. Specifically, for example, in a case where the button 805 of the screen 800 is pressed, it is determined that image characteristics are to be added. If it is determined that image characteristics are to be added, the processing proceeds to step S507. On the other hand, if it is determined that image characteristics are not to be added, the processing proceeds to step S508. The case where the processing proceeds to step S508 is, for example, a case where the user selects a desired image 801 by a checkbox 802 and presses the enter button 803.

In step S507, the CPU 201 accepts input of image characteristics from the user through the display unit 212. Specifically, for example, the CPU 201 displays a UI screen 900 as illustrated in FIG. 9 on the display unit 212. As illustrated in FIG. 9, the UI screen 900 displays a message asking “What are the characteristics you wish to add?” and an input region 901 for additionally accepting characteristics of an image that the user wants to generate. In FIG. 9, an example in which the input region 901 accepts the input such as “at dusk” is illustrated. In this way, the user can view the generated images and additionally input characteristics and cause the generation of the image to be performed again.

In step S508, the CPU 201 determines whether the enter button 803 has been pressed. When it is determined that the enter button 803 has not been pressed, the processing from step S505 is repeated. When it is determined that the enter button 803 has been pressed, the processing proceeds to step S509.

In step S509, the CPU 301 stores information of the selected image 801 in the cooperation region of the OS. As a result, the OS notifies the predetermined app, and the predetermined app can acquire the information of the selected image 801 from the OS cooperation region.

In the above example, an example has been described in which a condition (for example, an aspect ratio of a postcard) based on information of a sheet set in a printing apparatus is automatically added to a query as a condition. However, limitation is not made to this example, and other conditions may be automatically added to the query as long as the output condition can be acquired in advance by the generative AI app. For example, it may be automatically added to the query that images are to be generated at a one-to-one aspect ratio based on the fact that the predetermined app is of a specific SNS application type.

Further, the predetermined app may add a query corresponding to the state of the apparatus that is to output the image. For example, when the predetermined app stores, in the cooperation region of the OS, information indicating that cyan ink is low in the printing apparatus 101, which is capable of communication, it may be added to the query that cyan ink is to be excluded from the colors constituting the images to be outputted. Further, for example, it may be added to the query that the only colors that are to constitute the output image are magenta, yellow, black, and white, and mixtures thereof. Also, for example, if the size of the paper set in the printing apparatus 101, which is capable of communication, is A4, it may be automatically added to the query that generation is to be such that the aspect ratio is as in the A4 size. Further, when the predetermined app has stored, in the OS cooperation region, information (i.e., capability information of the output destination) indicating that the output destination for outputting the generated image is a display with an aspect ratio of 16:9 whose number of pixels is 1920 pixels×1080 pixels, the aspect ratio and the number of pixels (resolution) may be automatically added to the query. In addition, when the predetermined app stores information on the number of colors and the dynamic range that can be reproduced at the output destination in the OS cooperation region, the number of colors and the dynamic range may be added to the query. Similarly, in a case where the predetermined app stores in the cooperation region of the OS, as a capability of the output destination, information obtained from capability information of the output destination, such as luminance, bit depth, frame rate, color gamut, whether display is possible with an HDR (High Dynamic Range), or whether display is possible with an SDR (Standard Dynamic Range), the information may be automatically added to the query.

Further, the present embodiment is not limited to a generative AI system that generates images, and can also be applied to a generation system that generates other content. For example, in a configuration in which a query is transmitted to a generative AI system (generative AI server) that generates speech, information such as a sound range (dynamic range) and a time may be acquired as information held by the predetermined app in addition to a prompt inputted by the user, and the information may be automatically added to the query. Further, in a configuration in which a query is transmitted to a generative AI system that generates a moving image, for example, information such as a time limit may be acquired as information held by the predetermined app as information of an output destination (for example, a moving image posting site serving as an output destination) in addition to a prompt inputted by the user, and the information may be automatically added to the query. Further, in a configuration in which a query is transmitted to a generative AI system that generates text, for example, information such as a limit on the number of characters or an available character type may be acquired as information of an output destination in addition to a prompt inputted by the user, and the information may be automatically added to the query.

Note that the various kinds of control described above as being performed by a CPU may be performed by one piece of hardware, or may be performed by a plurality of pieces of hardware (for example, a plurality of processors or circuits) dividing up processing to control the entire apparatus.

Also, while the present disclosure has been described in detail based on the preferred embodiments thereof, the present disclosure is not limited to these particular embodiments, and various modes within the scope that do not depart from the gist of the present disclosure are also included in the present disclosure. Furthermore, each of the above-described embodiments merely illustrates an example of the present disclosure, and each of the embodiments can be combined as appropriate.

Further, in the above-described embodiment, a case in which the present disclosure is applied to the printing apparatus 101 and the PC 105 as given as an example, but limitation is not made to this example, and any electronic device capable of executing a predetermined app can be applied. That is, the present disclosure is applicable to a personal computer, a PDA, a mobile telephone terminal, a portable image viewer, a printer apparatus including a display, a digital photo frame, an electronic book reader, a camera, and the like.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-160327, filed Sep. 17, 2024 which is hereby incorporated by reference herein in its entirety.

What is claimed is:

1. An electronic device, comprising:
at least one memory and at least one processor which function as:
an acceptance unit configured to accept, from a user, input of a characteristic of content to be generated;
an acquisition unit configured to acquire information of an output destination of the content to be generated;
an input unit configured to perform control so as to input, into a content generation unit, a query including information representing the characteristic of the content to be generated for which input has been accepted by the acceptance unit and information of the output destination acquired by the acquisition unit; and
an output unit configured to perform control to output, to the output destination, content generated by the content generation unit based on the query.

2. The electronic device according to claim 1, wherein the content is an image.

3. The electronic device according to claim 2, wherein the information of the output destination includes an aspect ratio.

4. The electronic device according to claim 3, wherein the query is a query for making a request to the content generation unit so as to generate an image corresponding to the aspect ratio.

5. The electronic device according to claim 3, wherein
the output destination is a printer, and
the aspect ratio is information based on a sheet set in the printer.

6. The electronic device according to claim 3, wherein
the output destination is an SNS (Social Networking Service) application, and
the aspect ratio is information based on a condition for posting to the SNS application.

7. The electronic device according to claim 2, wherein the information of the output destination includes a resolution.

8. The electronic device according to claim 7, wherein the query is a query for making a request to the content generation unit so as to generate an image corresponding to the resolution.

9. The electronic device according to claim 2, wherein the information of the output destination includes information related to at least one of a sheet, a color material, a dynamic range, a luminance, a bit depth, a frame rate, a color gamut, whether display is possible with an HDR (High Dynamic Range), and whether display is possible with an SDR (Standard Dynamic Range).

10. The electronic device according to claim 2, wherein the image includes a still image or a moving image.

11. The electronic device according to claim 1, wherein the content includes sound.

12. The electronic device according to claim 10, wherein information of the output destination includes information related to time.

13. The electronic device according to claim 1, wherein the content includes text.

14. The electronic device according to claim 13, wherein the information of the output destination includes information related to at least one of a limit on a number of characters and what characters are available.

15. The electronic device according to claim 1, wherein
the electronic device comprises a first application and a second application different from the first application,
the first application comprises the output unit,
the second application comprises the acceptance unit, the acquisition unit, and the input unit, and
the information of the output destination is information that the first application holds.

16. The electronic device according to claim 15, wherein
the first application stores information of the output destination in a storage unit of the electronic device, and
the acquisition unit acquires the information of the output destination that is stored in the storage unit.

17. The electronic device according to claim 16, wherein the first application acquires content generated by the content generation unit, and the output unit performs control so as to output the acquired content.

18. The electronic device according to claim 17, wherein
the second application stores in the storage unit the content generated by the content generation unit, and
the first application acquires the content generated by the content generation unit that is stored in the storage unit.

19. The electronic device according to claim 16, wherein the storage unit is included in an operating system that is different from the first application and is different from the second application.

20. The electronic device according to claim 1, wherein the content generation unit is a generative AI (Artificial Intelligence) system.

21. The electronic device according to claim 1, wherein the content generation unit is a system that is external to the electronic device.

22. A method for controlling an electronic device that is executed in the electronic device, the method comprising:
accepting, from a user, input of a characteristic of content to be generated;
acquiring information of an output destination of the content to be generated;
performing control so as to input, into a content generation unit, a query including information corresponding to a characteristic of the content to be generated for which input has been accepted and the acquired information of the output destination; and
performing control to output, to the output destination, content generated by the content generation unit based on the query.

23. A non-transitory computer-readable storage medium that stores one or more programs including instructions, which when executed by one or more processors of an electronic device, cause the electronic device to:
accept, from a user, input of a characteristic of content to be generated;
acquire information of an output destination of the content to be generated;
perform control so as to input, into a content generation unit, a query including information corresponding to a characteristic of the content to be generated for which input has been accepted and the acquired information of the output destination; and
perform control to output, to the output destination, content generated by the content generation unit based on the query.
